(19) United States
(12) Patent Application Publication
(10) Pub. No.: US 2008/0138089 A1
(43) Pub. Date: Jun. 12, 2008

(54) OPTICAL TRANSMITTER

(76) Inventors: Shigeru Tokita, Yokohama (JP); Hiroo Matsue, Yokohama (JP); Antony Cleitus, Cork (IE)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/946,952

(22) Filed: Nov. 29, 2007

(30) Foreign Application Priority Data
Nov. 29, 2006 (JP) 2006-321962

(51) Int. Cl. H04B 10/04

(52) U.S. Cl. 398/183

(57) ABSTRACT

In an optical transmitter, a light-emitting device, a modulator that outputs a differential modulation current via alternating current coupling capacitors to an anode terminal and a cathode terminal of the light-emitting device, a first current source between the cathode terminal and a ground line (GND) of the light-emitting device, and a second current source between the anode terminal and a power source line (Vcc) of the light-emitting device, are provided.

### CLAIM OF PRIORITY

The present application claims priority from Japanese patent application serial no. 2006-321962, filed on Nov. 29, 2006, the content of which is hereby incorporated by reference into this application.

### BACKGROUND OF THE INVENTION

The present invention relates to an optical transmitter, and in particular to an optical transmitter for an optic fiber communications system.

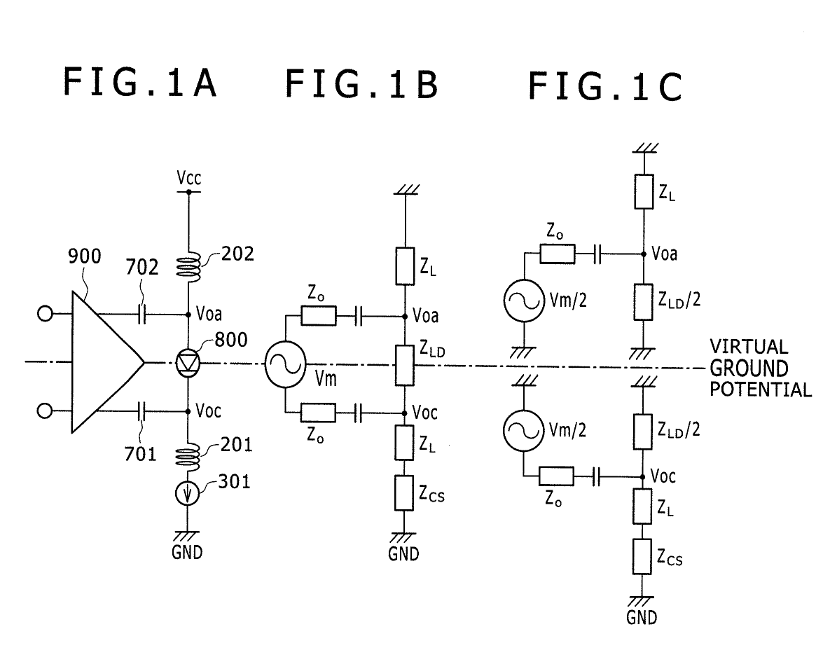

The optical transmitter circuit of FIG. 1 described in JP-A 2004-193489 includes a laser diode 100, a modulator 115 that supplies a modulation current via alternating current coupling capacitors 107, 108, and a current source 103 that supplies a bias current via bias tees 102, 101 which are inductors.

In this optical transmitter circuit, an inductor is provided on the cathode side terminal and the anode side terminal of the laser diode, and is configured to have high impedance to alternating current signals such as modulation currents. This inductor suppresses leak of modulation current to the current source, ground line and power source line, so that the modulation current flows efficiently into the laser diode.

The actual current source may be a bipolar transistor or a field effect transistor. The inductor, considering packaging area and rated allowable current, may be a chip inductor or a chip bead both having an inductance of several-several tens of micro Henries.

In the optical transmitter circuit described in JP-A 2004-193489, a modulation current having various frequency components such as a pseudo-random pattern is supplied to a laser diode as a differential alternating current signal. On the other hand, in the construction of the bias circuit connected to the anode part and cathode part of the laser diode, the devices were not respectively symmetrical. Specifically, the anode was connected to a power source line of low impedance via an inductor, while the cathode was connected to a ground line of low impedance via an inductor and a current source. Due to this, the impedances in the anode and in the cathode of the laser diode were sometimes not equal, and the differential balance collapsed. This will be explained referring to FIG. 1.

FIGS. 1A to 1C show an optical transmitter circuit and its equivalent models. In FIG. 1A, a modulator 900 was modeled by an output modulation voltage Vm and output impedance Zo, the equivalent impedances of a laser diode 800, inductors 201, 202 and current source 301 being respectively ZLD, ZL, and ZCS. Here, capacitors 701 and 702 are alternating current coupling capacitors. If this is modeled, the equivalent model shown in FIG. 1B is obtained. Since the modulation current is a differential signal, in FIG. 1C, an equivalent model is shown where a virtual ground potential is provided respectively for the anode and cathode side. As shown by the model of FIG. 1C, if Voa is the voltage at the anode terminal of the laser diode 800, Voc is the voltage at the cathode terminal of the laser diode 800, ZL is the equivalent impedance of the inductors 201, 202, ZLD is the equivalent impedance of the laser diode 800, ZCS is the equivalent impedance of the current source 301, Zo is the equivalent impedance of the output of the modulator 900, and Vm is the output modulation voltage of the modulator 900, equation (2) and equation (3) are obtained, respectively, as transmission functions of the anode and cathode. Equation (1) defines a computation.

$$\begin{matrix}{Z}_{LD} // {Z}_{L} = \frac{{Z}_{LD} - {Z}_{L}}{{Z}_{LD} + {Z}_{L}} & ( 1 ) \\ \frac{Voa}{Vm} = \frac{{Z}_{LD} // {Z}_{L}}{2 ( Zo + {Z}_{LD} // {Z}_{L} )} & ( 2 ) \\ \frac{Voc}{Vm} = \frac{{Z}_{LD} // ( {Z}_{L} + {Z}_{CS} )}{2 \{ Zo + {Z}_{LD} // ( {Z}_{L} + {Z}_{CS} ) \}} & ( 3 )\end{matrix}$$

Compared to equation (2), equation (3) includes terms containing the equivalent impedance ZCS of the current source, and equation (2) and equation (3) do not coincide. From this, it is clear that the impedances in the anode and cathode of the laser diode 800 are not equal, and the differential balance may collapse.

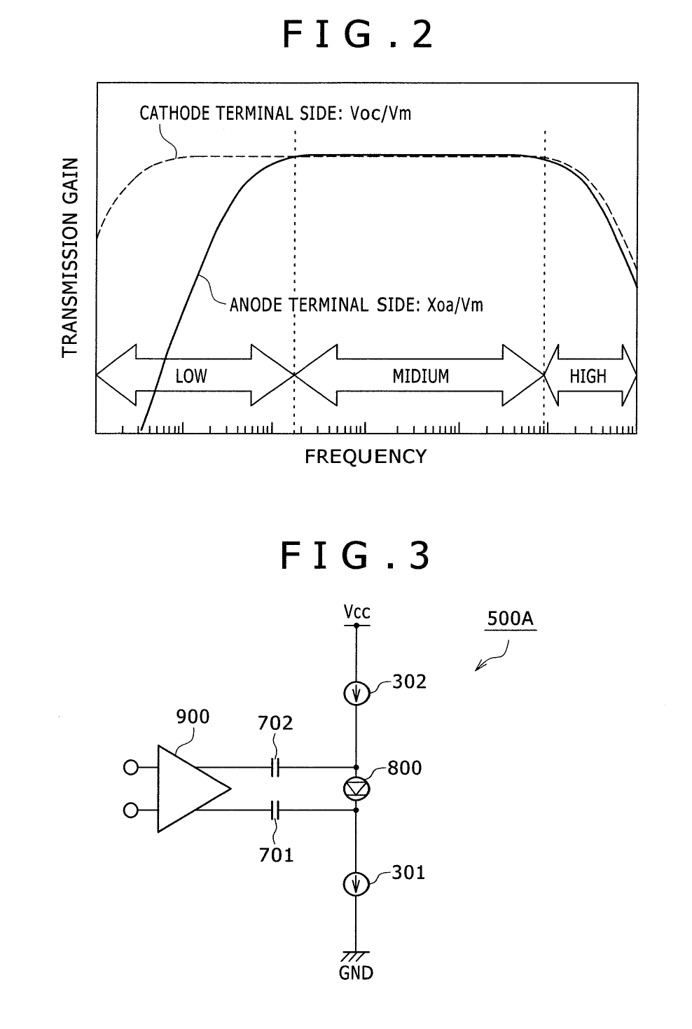

FIG. 2 is a diagram describing the frequency dependence of the transmission function of the anode and the cathode. In FIG. 2, the vertical axis is transmission gain, the horizontal axis is frequency, and the transmission characteristics of the anode and cathode have a substantially equal transmission gain in the midrange frequency region. However, in the low-pass frequency range and high-pass frequency range, the transmission gain is different. In the low-pass frequency region and high-pass frequency region, since a symmetrical modulation current waveform is not obtained at the cathode terminal and anode terminal of the laser diode, it causes radiation of electromagnetic wave noise and deterioration of the light waveform.

### SUMMARY OF THE INVENTION

The invention provides an optical transmitter wherein a symmetrical modulation current wave is obtained at the cathode terminal and anode terminal of a laser diode, and there is little radiation of electromagnetic wave noise and deterioration of the light waveform.

These problems are resolved by an optical transmitter including a light-emitting device, a modulator that outputs a differential modulation current via alternating current coupling capacitors to an anode terminal and a cathode terminal of the light-emitting device, a first current source between the cathode terminal and ground line of the light-emitting device, and a second current source between the anode terminal and power source line of the light-emitting device.

### BRIEF DESCRIPTION OF THE DIAGRAMS

Preferred embodiments of the present invention will now be described in conjunction with the accompanying drawings, in which:

FIGS. 1A to 1C are diagrams describing an optical transmitter and its equivalent model;

FIG. 2 is a diagram describing a frequency dependence of a transmission function of an anode and a cathode;

FIG. 3 is a circuit diagram of an optical transmitter according to a first embodiment;

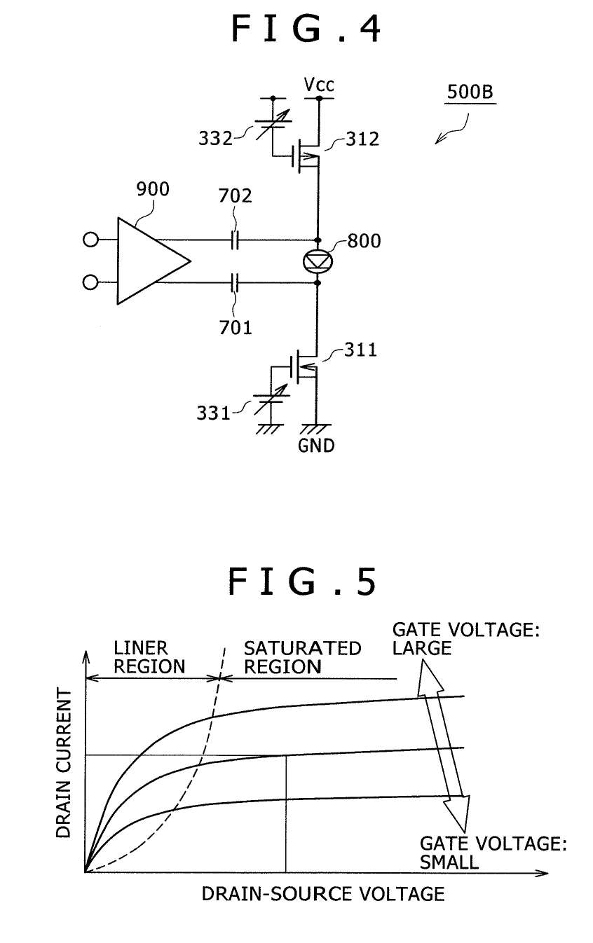

FIG. 4 is a circuit diagram of another optical transmitter according to the first embodiment;

FIG. 5 is a diagram describing the properties of a field effect transistor;

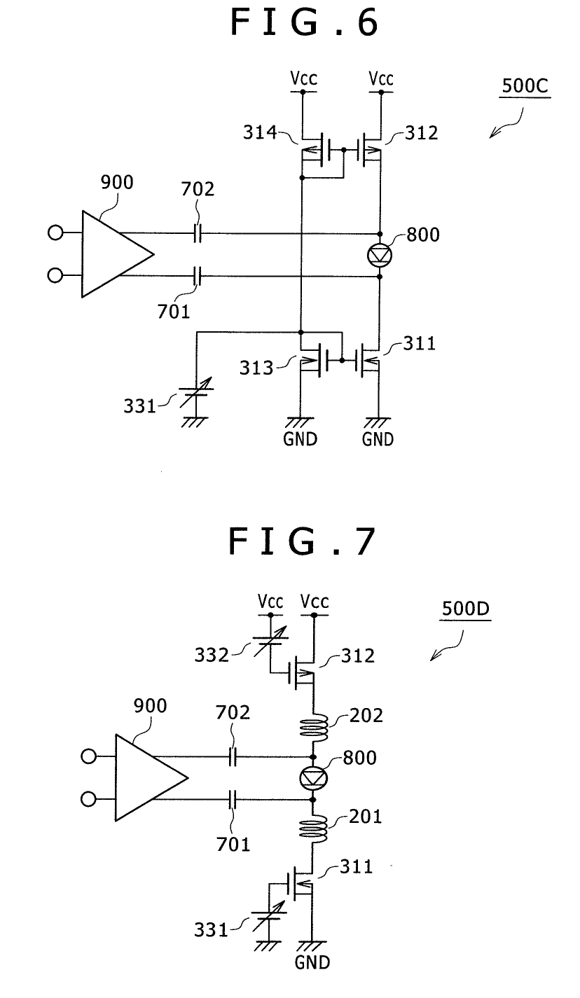

FIG. 6 is a circuit diagram of an optical transmitter according to a second embodiment;

FIG. 7 is a circuit diagram of an optical transmitter according to a third embodiment;

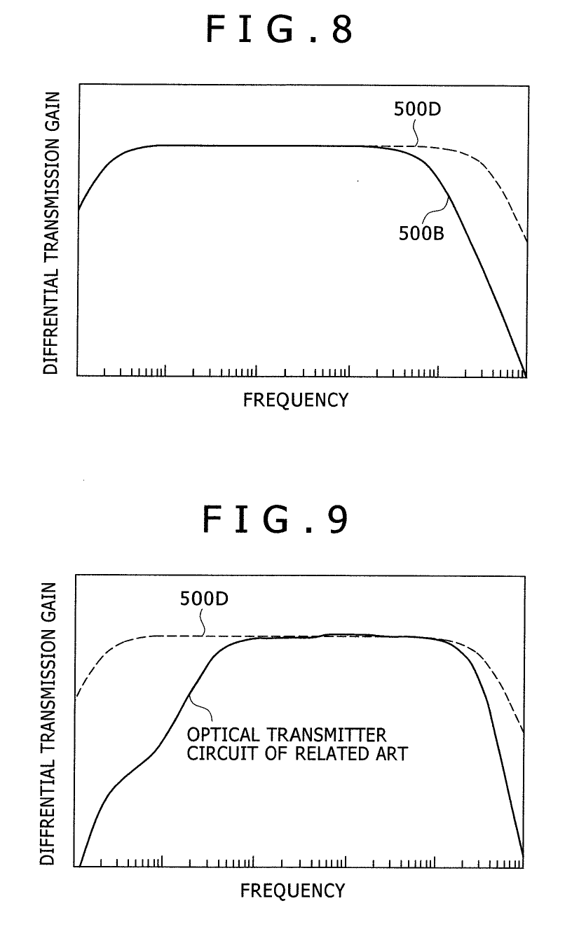

FIG. 8 is a (first) diagram describing the characteristics of the frequency dependence of a differential transmission gain;

FIG. 9 is a (second) diagram describing the characteristics of the frequency dependence of a differential transmission gain; and

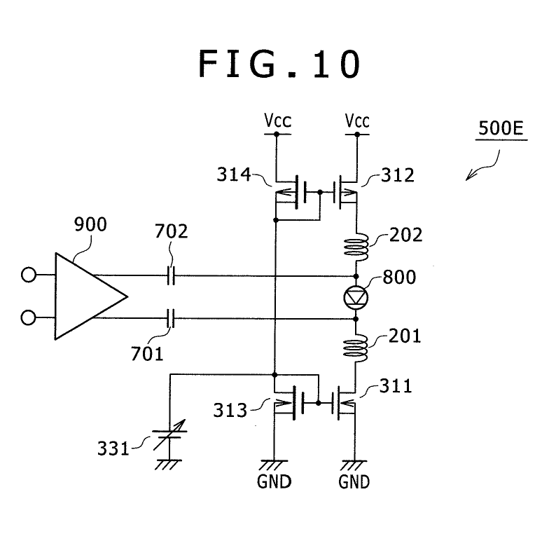

FIG. 10 is a circuit diagram of an optical transmitter according to a third embodiment.

### DESCRIPTION OF THE PREFERRED EMBODIMENTS

Hereafter, some embodiments of the invention will be described in detail referring to the diagrams.

### First Embodiment

A first embodiment of the invention will now be described referring to FIGS. 3 to 5. Here, FIGS. 3 and 4 are circuit diagrams of an optical transmitter. FIG. 5 is a diagram describing the properties of a field effect transistor.

In FIG. 3, an optical transmitter 500A includes a laser diode 800, a modulator 900 which supplies a modulation current via alternating current coupling capacitors 701, 702, a current source 301 on the cathode terminal side of the laser diode 800, and a current source 302 on the anode terminal side of the laser diode 800.

The modulator 900 outputs a modulation current according to a signal supplied to the input of the modulator, and a high level/low level light intensity signal is generated by the laser diode 800. In addition to the modulation current, a bias current is supplied to the laser diode 800 by the current sources 301, 302.

As specific examples of the current sources 301, 302 shown in FIG. 3, FIG. 4 shows an optical transmitter where a field effect transistor is the current source.

In FIG. 4, an optical transmitter 500B is provided with a N channel field effect transistor 311 as the cathode terminal side of the laser diode 800, and a voltage source 331 which voltage-controls the N channel field effect transistor 311. A P channel field effect transistor 312 and a voltage source 332 which voltage-controls the P channel field effect transistor 312, are further provided on the anode terminal side of the laser diode 800.

In FIG. 5, the vertical axis is drain current, the horizontal axis is drain-source current, and the gate voltage is set as a parameter. Since the drain current hardly varies with the drain-source voltage variation in the saturation region, the field effect transistor has a large equivalent impedance. Due to this property, the ground line and flow of modulation current to the ground line are suppressed, and the laser diode 800 can be driven efficiently.

In the optical transmitter 500B, the current sources 301, 302 are provided respectively to each of the cathode terminal and anode terminal of the laser diode 800. Due to this, the impedance of the cathode terminal and the impedance of the anode terminal become comparable. Therefore, since a differential balance is maintained, radiation of electromagnetic wave noise and deterioration of the light waveform are suppressed.

In FIG. 4, a field effect transistor is used, but since a bipolar transistor has a high impedance like a field effect transistor, a bipolar transistor may also be used for the current sources 301, 302.

### Second Embodiment

A second embodiment will now be described referring to FIG. 6. Here, FIG. 6 is a circuit diagram of an optical transmitter.

In FIG. 6, an optical transmitter 500C has a second N channel field effect transistor 313 and second P channel field effect transistor 314 instead of the voltage source 332 of the optical transmitter 500B. The first N channel field effect transistor 311 and second N channel field effect transistor 313 are set using a device of identical gate width so that the same drain current value flows. Therefore, when a gate voltage is applied by the voltage source 331, the same drain current value as that of the first N channel field effect transistor 311 is reflected in the second N channel field effect transistor 313. The drain current generated by the second N channel field effect transistor 313 is transmitted to the second P channel field effect transistor 314 to which the drain terminal and gate terminal are connected, and the first P channel field effect transistor 312 to which the gate terminal is connected. Due to this current mirror connection, in the first N channel field effect transistor 311 and P channel field effect transistor 312, a substantially identical drain current can be generated and the bias current can be controlled by the single voltage source 331.

In the above embodiment, the gate widths of the N channel field effect transistors 311, 313 or the P channel field effect transistors 312, 314 are both made equal, but the ratio of these gate widths may be made N to 1. By setting the ratio of gate widths to N to 1, the ratio of drain currents flowing in the N channel field effect transistors 311, 313 or P channel field effect transistors 312, 314 can be set to N to 1. Hence, the current used in the current mirror circuit can be suppressed, and power consumption can be reduced.

### Third Embodiment

A third embodiment will now be described referring to FIGS. 7 to 9. Here, FIG. 7 is a circuit diagram of an optical transmitter. FIGS. 8 and 9 are diagrams describing the frequency dependence of differential transmission gain.

In FIG. 7, an optical transmitter 500D is further provided with the inductors 201, 202 in each of the cathode terminal and the anode terminal of the laser diode 800 of the optical transmitter 500B, and a faster modulation rate is achieved. In general, a field effect transistor which is a discrete component has a drain terminal capacity of several tens-several 100 picofarads. If the inductors 201, 202 are not provided as in the optical transmitter 500B, the modulation current flows into the ground line via the drain terminal capacitance as the modulation frequency becomes higher, and is not efficiently transmitted to the laser diode 800. Hence, it was difficult to suppress bandwidth, and difficult to achieve a high speed modulation rate.

On the other hand, the optical transmitter 500D has a construction wherein the inductors 201, 202 are provided to suppress the modulation current flowing in the drain terminal capacitance of the N channel field effect transistor 311 and P channel field effect transistor 312.

FIG. 8 illustrates the frequency characteristic of the differential transmission gain of the optical transmitter 500B and the optical transmitter 500D which are provided with the inductors 201, 202. From FIG. 8, it is clear that by providing the inductors 201, 202, an improved modulation rate can be achieved.

FIG. 9 is a diagram describing an optical transmitter according to the related art, and the frequency dependence of the differential transmission gain of the optical transmitter 500D. It is seen that, compared with the optical transmitter of the related art, the optical transmitter 500D makes it possible to obtain a fixed transmission gain down to a lower passband.

The impedance of the inductors 201, 202 is a property which becomes smaller as the frequency becomes smaller. In the optical transmitter of the related art, since the anode terminal of the laser diode is connected to a power source line of low impedance via the inductor 202, the impedance of the inductor 202 falls as the frequency becomes lower, and due to current flow to the power source line of the modulation current, it is no longer efficiently transmitted to the laser diode. For this reason, in FIG. 9, this causes a decrease of transmission gain on the low passband side.

On the other hand, since the optical transmitter 500D is provided with a high impedance current source including the P channel field effect transistor 312 in addition to the inductor 202, current outflow to the power source line of the modulation current is suppressed even if the impedance of the inductor 202 decreases. Hence, the optical transmitter 500D can provide a fixed transmission gain down to a lower passband than the optical transmitter of the related art. Specifically, by applying the optical transmitter 500D, the differential balance between the anode terminal and the cathode terminal of the laser diode 800 is maintained, and a fixed transmission gain can be achieved over a wide frequency range.

### Fourth Embodiment

A fourth embodiment will now be described referring to FIG. 10. Here, FIG. 10 is a circuit diagram of an optical transmitter.

In FIG. 10, an optical transmitter 500E has a construction wherein the N channel field effect transistor 313 and the second P channel field effect transistor 314 are provided instead of the voltage source 332 of the optical transmitter 500D. This makes it possible to provide symmetry and a wide bandwidth of the differential circuit which are features of the optical transmitter 500D, and control two current sources, i.e., the P channel field effect transistor 312 and N channel field effect transistor 311, by the single voltage source 331.

According to all of the above embodiments, electromagnetic radiation and deterioration of the light waveform can be suppressed, and a broadband optical transmitter can be provided.

What is claimed is:

1. An optical transmitter, comprising a light-emitting device, a modulator that outputs a differential modulation current via an alternating current coupling capacitor to each of an anode terminal and a cathode terminal of the light-emitting device, a first current source between the cathode terminal and a ground line of the light-emitting device, and a second current source between the anode terminal and a power source line of the light-emitting device.

2. The optical transmitter according to claim 1, wherein a first NPN bipolar transistor is used as the first current source, and a first PNP bipolar transistor is used as the second current source.

3. The optical transmitter according to claim 1, the transmitter using a first N channel field effect transistor as the first current source, and a first P channel field effect transistor as the second current source.

4. The optical transmitter according to claim 2, the transmitter having:
a second NPN bipolar transistor that generates a collector current proportional to the collector current flowing in the first NPN bipolar transistor; and
a second PNP bipolar transistor that controls the base voltage of the first PNP bipolar transistor by the collector current of the second NPN bipolar transistor,
wherein the collector currents flowing in the first NPN bipolar transistor and first PNP bipolar transistor are equal or proportional.

5. The optical transmitter according to claim 3, the transmitter having:
a second N channel field effect transistor that generates a drain current proportional to the drain current flowing in the first N channel field effect transistor, and a second P channel field effect transistor that controls the gate voltage of the first P channel field effect transistor by the drain current of the second N channel field effect transistor,
wherein the collector currents flowing in the first N channel field effect transistor and first P channel field effect transistor are equal or proportional.

6. The optical transmitter according to claim 1, the transmitter having a first inductor that connects the cathode terminal with the first current source, and a second inductor that connects the anode terminal with the second current source.

7. The optical transmitter according to claim 2, the transmitter having a first inductor that connects the cathode terminal with the first NPN bipolar transistor, and a second inductor that connects the anode terminal with the first PNP bipolar transistor.

8. The optical transmitter according to claim 4, the transmitter having a first inductor that connects the cathode terminal with the first NPN bipolar transistor, and a second inductor that connects the anode terminal with the first PNP bipolar transistor.

9. The optical transmitter according to claim 3, the transmitter having a first inductor that connects the cathode terminal with the first N channel field effect transistor, and a second inductor that connects the anode terminal with the first P channel field effect transistor.

10. The optical transmitter according to claim 5, the transmitter having a first inductor that connects the cathode terminal with the first N channel field effect transistor, and a second inductor that connects the anode terminal with the first P channel field effect transistor.
